(19) United States
(12) Patent Application Publication
(10) Pub. No.: US 2015/0142434 A1
(43) Pub. Date: May 21, 2015

(54) Illustrated Story Creation System and Device

(71) Applicants: David Wittich, Boca Raton, FL (US); Barbara Banks-Wittich, Boca Raton, FL (US)

(72) Inventors: David Wittich, Boca Raton, FL (US); Barbara Banks-Wittich, Boca Raton, FL (US)

(21) Appl. No.: 14/085,703

(22) Filed: Nov. 20, 2013

(51) Int. Cl. G10L 15/26; G10L 21/10

(52) U.S. Cl. CPC G10L 15/26; G10L 21/10
USPC 704/235

(57) ABSTRACT

The present invention is directed to a method and device to create an illustrated story or narrative. As user dictates a narrative or story the users voice is recognized by a computer program operated on a computer and translated to text. The computer includes a microphone, a processor, and a display and can access a database that includes images. A program then interprets the text using an algorithm to select particular words from the translated text and associates an image file from the database that correspond to the selected words. The user may optionally provide other input with to select characters, themes, and objects. An algorithm processes the input from these various sources and displays the selected image.

The Applicant's claim the benefit of the filing date of U.S. Application No. 61/728,784 filed on Nov. 20, 2012. The present is invention is directed to a method and device to create an illustrated story. According to the invention, as user dictates a narrative or story, his or her voice is recognized by a computer program and translated to text. Next, a program interprets the text using an algorithm to select particular words from the translated text associates an image file from a database that correspond to the selected words. Next, the algorithm displays the selected image either by a static display or is created as the user watches the creation of a dynamic line drawing. In embodiments, the text that has been translated from an audio signal to written text that is also displayed on the display panel. In other embodiments, certain images displayed on the screen are associated with an application that provides animation to a portion of the image.

### BACKGROUND OF THE INVENTION

The present invention relates generally to a system and method for generating and illustrating a story. As the user dictates a story and a voice recognition system converts the audio signal to text or other machine readable medium. The text or other machine readable data is then processed using an algorithm that correlates the text signal to a display to provide and image or illustration that corresponds or has otherwise been associated with the recognized terms. The system allows a user to therefore dictate a story and graphics having preselected features are displayed as the story progresses. Because the narrative of the story can change in each use, the graphics that are displayed will change in response to changes in the narrative. In a first embodiment, the images are selected from an image database that share the same look and feel.

### DESCRIPTION OF THE PRIOR ART

There are a number of systems and devices designed to encourage and promote language skills, storytelling and creative writing. Such systems include books and the like, games, and electronic or computerized systems.

A basic system is provided in book form or, alternatively, as stationery for writing stories or narratives. For example, the patents to Ellenbogen U.S. Pat. No. 5,551,878, and 5,660,548, disclose a method to improve writing skills through the use of writing template having distinct regions one of which includes a plurality of thematic markings. An individual can refer to the thematic markings in composing and writing the text of the letter.

The patent to Koke U.S. Pat. No. 5,306,155, discloses a creative writing book to teach and encourage writing skills, which book includes a picture printed on each leaf of a tear-off pad with space provided for a learner to generating writing to form a story which the learner imagines from viewing the picture. Similarly, U.S. Pat. No. 4,943,088, which issued to Wada discloses a picture book including a resinous coating upon which a child can paint or write by means of a pen containing water-soluble ink so as to add his or her imaginary expressions to the story.

Games are also used to encourage creative writing and storytelling. The patent to Mullins U.S. Pat. No. 5,100,154, which issued to Mullins on Mar. 31, 1992 for a “Timed Group-Writing Game With Random Characterizations.” Mullins teaches the use of a time limited game for a group of players to share in the composition of several short stories, including the means to achieve this composition. Said means include character profile cards and a spinner to determine the genre or category of the composition.

Another entertaining creative writing tool is disclosed in the patent to Bellizzi U.S. Pat. No. 5,657,992, which is a game system wherein a director distributes playing cards and scenario cards to players, who then attempt to creatively and amusingly play their cards to produce a story line. The game is designed to both entertain and educate players with current art, literature, drama, comedy, films and celebrities.

There are also computerized systems for assisting and encouraging individuals in developing their creative writing skills. For example, the patent to Pellegrino U.S. Pat. No. 6,149,441, which includes a server computer and at least one client, whereby a lesson builder allows teachers to create customized lessons incorporating text, audio, images, video and application programs for delivery to the student user. The system is typically accessed by teachers and students via an Internet browser which receives web pages served from the server computer, which communicates with the client computer via an intranet or the Internet.

The patent to Siegel U.S. Pat. No. 6,009,397, discloses a method which allows a user to specify phenomes and the relative positions of phenomes with respect to a word or group of words, such as a title. Another patent to Seigel U.S. Pat. No. 6,148,286, discloses a method and apparatus which allows a user with minimal understanding of the orthography of a language to nevertheless use its orthography as the basis for performing a database search.

The patent to Anderson, U.S. Pat. No. 6,499,016, which is incorporated by reference herein, discloses a system that is designed to create a photo album from a collection of indexed photos using voice activated technology.

The patent to Kruse et al, U.S. Pat. No. 7,730 is directed to software program that constitutes an idea map which includes fields for images and text.

The patent to Spector, U.S. Pat. No. 6,227,836 discloses phonic training computer system that teaches spelling and reading and includes a voice recognition program and image database.

The patent to Burke U.S. Pat. No. 7,292,243 discloses, inter alia, graphic user interfaces that display text images, photo images and other graphic information that helps a user with access data stored in a computer or other machine.

The patent to Friedlander U.S. Pat. No. 6,859,211 discloses a system and method for generating an online and interactive story.

Such systems and devices, however, fail to offer the unique advantages and features contemplated by the present invention.

### OBJECTS OF THE INVENTION

Against the foregoing background, it is a primary object of the present invention to provide a system and method that allows individuals to dictate an essay, short story, or instructions and have the system locate and then display illustrations that convey or relate to each phrase or sentence, to result in an illustrated story creation.

It is a further object to provide machine executable code that provides animation effects to discrete elements reflected in an illustration that is set forth in the display.

It is still another object of the present invention to provide such a system and method that encourages an individual's imagination to create a story based upon preselected selected themes and items relevant to the preselected themes.

It is another object of the invention to provide a system and method that acts as a tool to assist in developing storytelling skills.

It is a further object of the invention to provide such a system and method that allows unique creative and illustrated stories that can be generated, saved and transmitted to others.

It is a further object of the invention, to provide a user a device and system that allows the user to capture images from the environment and then use the captured images to create an illustrated story.

It is another object of the present invention to provide such a system and method that is both educational and entertaining to utilize.

It is still another object of the present invention to provide such a system and method that associates images with commonly-used parts of speech and phrases, such as nouns, articles, verbs, prepositions, and conjunctives.

To the accomplishments of the foregoing objects and advantages, the present invention, in brief summary comprises a system and method for generating an interactive story wherein an individual selects a general theme, characters and other story options and next begins to dictate a story or narrative. The audio signal is converted to a text and broken into brief segments or sentences. An algorithm then associates an image from an image library with the sentences or phrases. The images in the imaged library are tagged with a plurality of terms and information relating the image to the theme and the terms that are used in the story that are dictated by the user. The images may be labeled with active and descriptive words relating to the picture. The algorithm will also recognize a set of pre-determined, commonly-used parts of speech and phrases, including articles, verbs, prepositions, and conjunctives.

### BRIEF DESCRIPTION OF THE DRAWINGS

The foregoing and still other objects and advantages of the present invention will be more apparent from the detailed explanation of the preferred embodiments of the invention in connection with the accompanying drawings, wherein:

FIG. 1 is a screenshot of an exemplary graphic user interface according to an embodiment of the invention.

FIG. 2 is a screenshot an exemplary graphic user interface according to an embodiment of the invention

FIG. 3 is a screenshot of an exemplary graphic user interface according to an embodiment of the invention

FIG. 4 is a screenshot of an exemplary graphic user interface according to an embodiment of the invention

FIG. 5 is a screenshot of an exemplary graphic user interface according to an embodiment of the invention

FIG. 6 is a flow chart generally depicting steps of an embodiment of the invention.

FIG. 7 is a flow chart depicting steps of an embodiment of the invention.

FIG. 8A is a flow chart depicting the sub steps of an embodiment of the invention relating to an amusement activity features, integrated guided learning feature and creative writing feature.

FIG. 8B is a continuation of the flow chart from FIG. 8A depicting additional steps of an embodiment of the invention

FIG. 9A is a flow chart depicting the sub steps of an embodiment of the invention relating to the creation and display of images.

FIG. 9B is a continuation of the flow chart from FIG. 9A depicting additional steps of an embodiment of the invention.

FIG. 10 is a flow chart depicting the sub steps of an embodiment of the invention.

FIG. 11 is a flow chart depicting the sub steps of an embodiment of the invention.

FIG. 12 is a flow chart depicting the sub steps of an embodiment of the invention.

FIG. 13 is a flow chart depicting the sub steps of an embodiment of the invention.

FIG. 14 is a flow chart depicting the sub steps of an embodiment of the invention.

FIG. 15 is a flow chart depicting the sub steps of an embodiment of the invention.

FIG. 16 is a flow chart depicting the sub steps of an embodiment of the invention.

FIG. 17 is a flow chart depicting the sub steps of an embodiment of the invention.

FIG. 18 is a flow chart depicting the sub steps of an embodiment of the invention.

FIG. 19A is a flow chart depicting the sub steps of an embodiment of the invention relating to edit and modify stories that are created, including adding sound effects and voice overs.

FIG. 19B is a continuation of the flow chart from FIG. 19A depicting additional steps of an embodiment of the invention.

FIG. 20 is a flow chart depicting the sub steps of an embodiment of the invention.

FIG. 21 is a schematic illustration of the interactive guidance feature of the invention.

FIG. 22 is schematic illustration of the interactive guidance feature of the invention further depicting alternative graphics that may be selected by the user.

FIG. 23 is a schematic illustration of the interactive guidance feature of the invention depicting a different set of images that are displayed a story progresses.

FIG. 24 is a schematic illustration of different modes of embodiments of the invention.

FIG. 25 is a sample image on graphic user interface, in part shown in phantom displayed in a tablet computer including a dashboard.

FIG. 26 is a sample graphic user interface, in part shown with character halo indicia, displayed in a tablet computer including a dashboard including a dashboard.

FIG. 27 is a schematic representation of a computer upon which the invention can be implemented.

### DETAILED DESCRIPTION

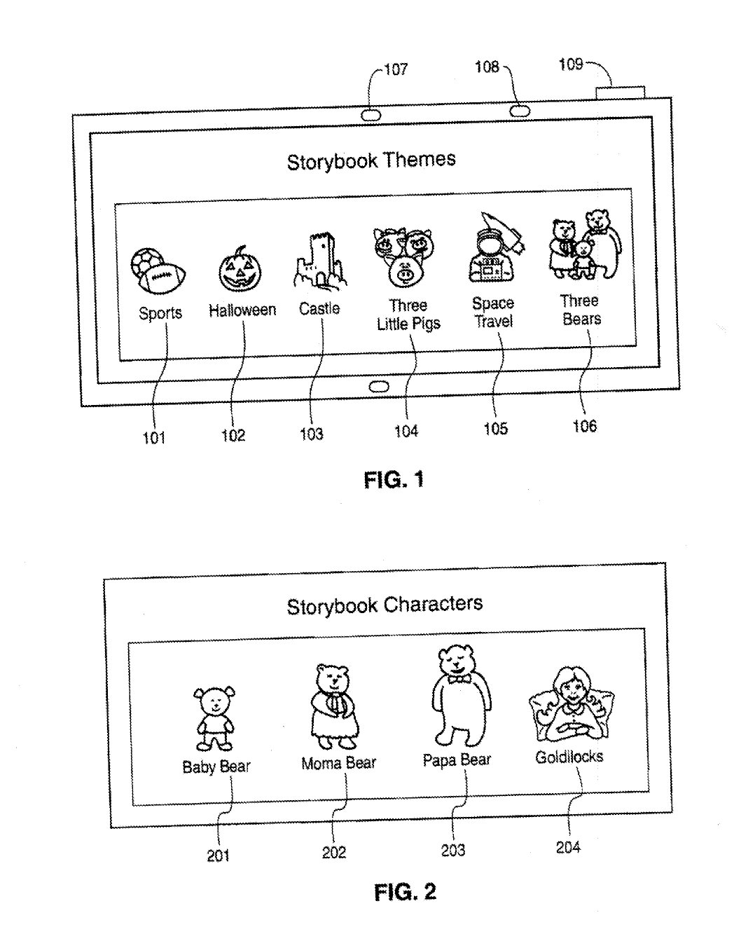

Specific embodiments of invention including systems and methods are described herein. Now referring to FIG. 1, in an embodiment the device is implemented on a tablet computer that includes a touchscreen display 101, a microphone 103, a processor (not shown), a camera 108, and a memory and activation switch 109. The tablet also includes a power source.

FIG. 1 includes a display on a graphic user interface of preselected themes that can be selected by the user to define the nature of the story told. The themes include sports 101, Halloween 102, Castle 103, Three Little Pigs. 104, space travel 105, and the three bears 106. The selection of the theme will correspondingly select a database of related images that are associated with the theme. The icons may be selected by touching the icon that is displayed. In alternative embodiments the icon may be selected by using a mouse pointer or other known navigational techniques, including voice activated commands.

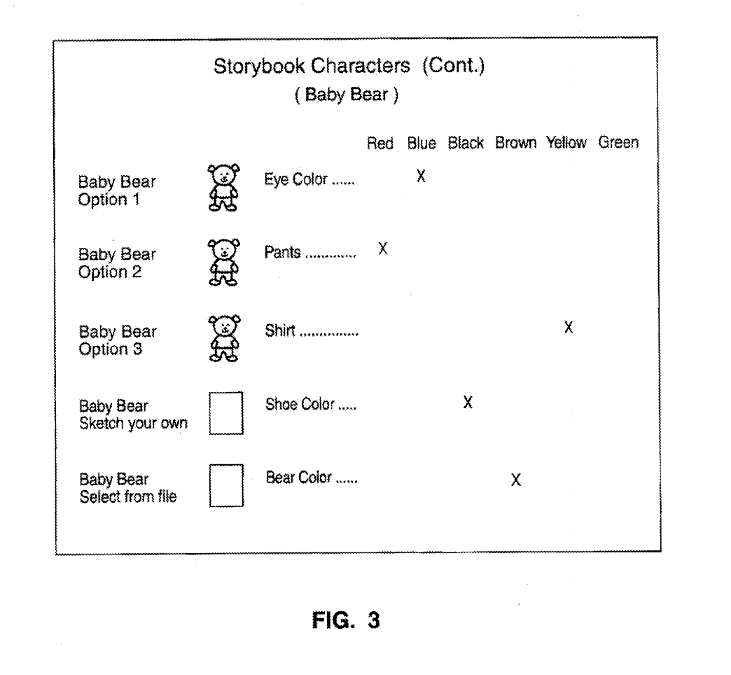

FIG. 2 depicts a graphic display of characters that may be selected from the “three bears” theme depicted in FIG. 1. The characters include baby bear 201, Mama Bear 202, Papa Bear 203 and Goldilocks 204. The selection of the character makes the characters accessible to the user and also provides a suggestion to the user to employ the selected character in the dictated story. As exemplified in depicted in FIG. 3, each character may then be customized based upon the preferences of the user. FIG. 3 depicts various options that allow the user to select a bear image, including options for the user to create his or own image and to a browser to select images from an external file. If an external file is selected, the image is processed by the image processing program to size the image and to define the edges of the images so that it can be integrated into the preexisting scenes associated with the themes. The options available to the user include selection of eye color 305, pants 306, shirt, 307, shoe color 308 and the color of the bear 309. When the image selected is from the browser, the options discussed are not operative.

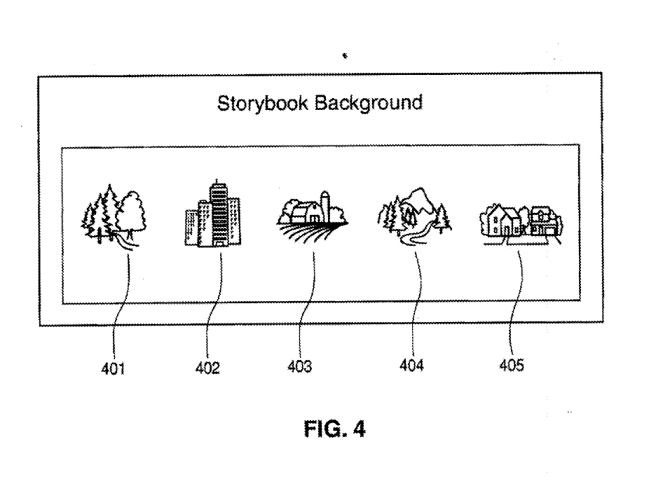

Now referring to FIG. 4, a further option made available to the user before the initiation of the dictation of the story is to select background scenes I which the characters and items are displayed. FIG. 4 includes woods 401, urban 403, country 404, mountain 405, and suburban scenes 406. The database includes multiple related versions of these scenes that may further include common items and found in the respective environment. For example, the country environment may include paths, barns, fences, farm animals, streams, cultivated fields, silos, trees and tractors. The selected characters would be into the scene and could interact with the displayed items based upon the commands proved by the user.

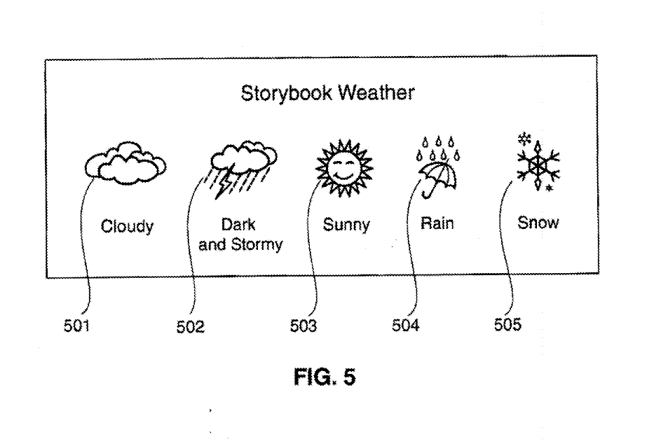

Now referring to FIG. 5, a further option that may be selected by the user is the weather conditions. These conditions include cloudy 505, dark and stormy 506, sunny 507, rainy 508, snowy 509, and windy 510. Once again, theses selection may be accessed by selecting the icon using a touch screen command. The selection of these options may also be performed by mouse pointer or other navigational techniques such as mouse pointer or voice commands. Other options, not shown, may also be provided to the user such as time of year, summer, winter, spring, summer, fall, which can alter the display of the foliage provided in the scenes. Thus, as shown in FIG. 4, in a further embodiment the is displayed a weather selection on the scene, for example, the environment may be snowing, raining, windy, sunny, cold or hot. The user can select a weather function and then apply the function on a particular scene. In an example, the user may begin the story with a cold and snowy environment. The processor would then display the presented and simulated snowfall would be displayed. The user could later alter the weather or time of day to correspondingly alter the display of the scene. This alteration can be performed by the language recognition program that relates to environmental conditions, (for example, it began to get dark, it began to rain, a storm was coming, etc,) or the user can return to the dashboard and input new environmental conditions.

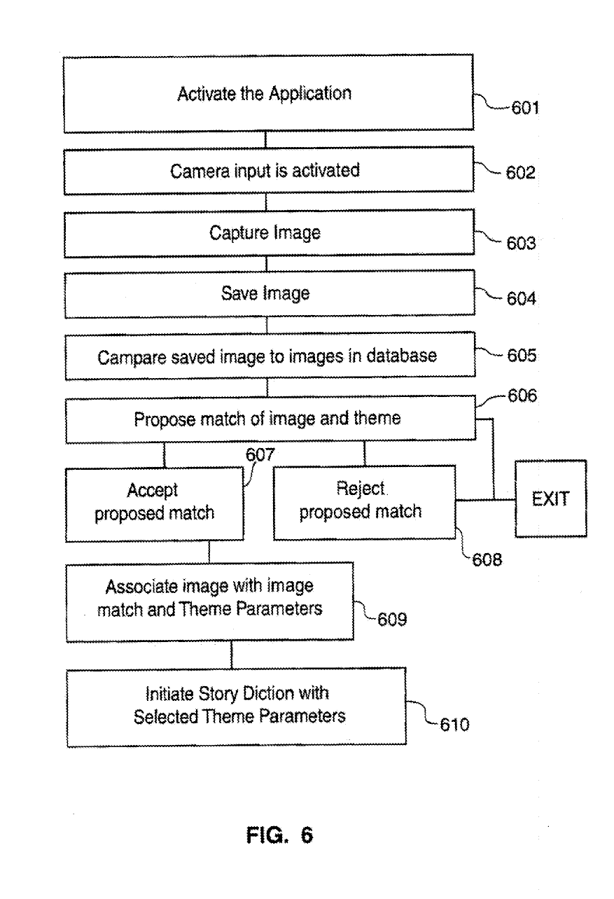

Now referring to FIG. 6, a method of an embodiment of the invention that includes a camera input begins at step 601, the activation the application on a device. Next, the camera input is activated 605 and an image is captured at step 608 and saved at step 609. At step 610 the image is compared to a database of previously saved images. If the processor recognizes a match of the capture image and an image in the database, the program moves to the next step, wherein the matched image is displayed to the user at step 612. The user can then either confirm the match or reject the match. If the match is confirmed the user can accept the propose match at step 615. Next the system associates image with other related images in the system. In this embodiment, an action figure, doll or plush toy may be provided along with the software that implements the system on a table device. When the system is initiated, the user can capture an image of the action figure, doll or plush is recognized by the system and preloaded themes, images, backgrounds, character and items relating to the action figure, doll or plush are selected for use in the narrated story.

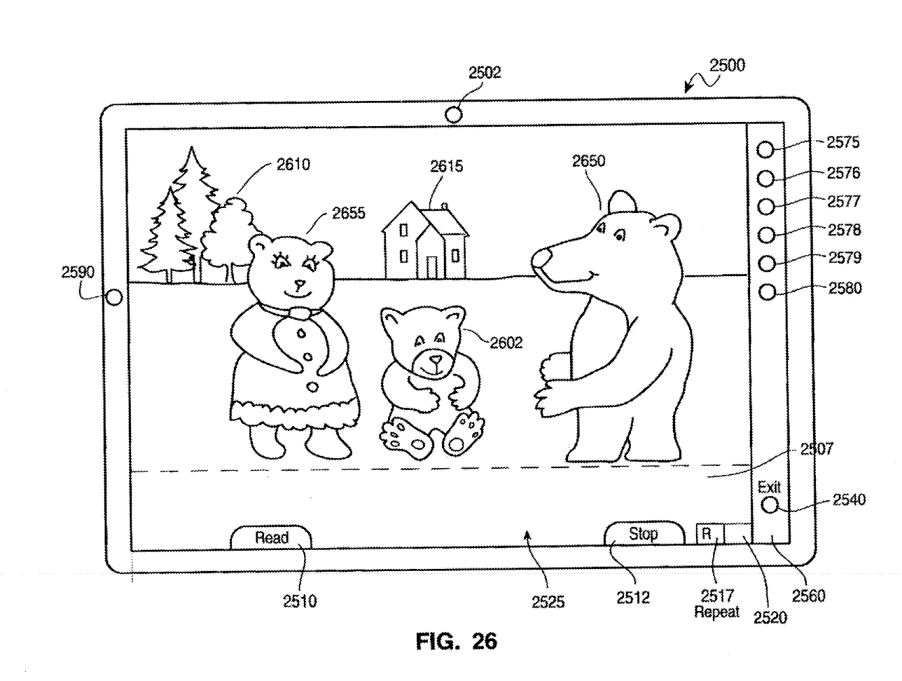

While primary input to the device is provided with a microphone, embodiments contemplate other inputs techniques. For example, the table computer comprises a touchscreen and, the images displayed on the touchscreen also are icons that are linked to an application menu. For example, each character or item has a boundary or edge that defines the item and the item can accessed by touching the icon. When the icon is touched, the outline of the item will be illuminated showing that it is condition for alteration. As best seen in FIG. 26, the image of the small bear has been activated as reflected by the halo effect provided on the image 2602. Next the icon can be increased in size or reduced in size using touch screen commands and the icon can be dragged to different locations on the screen or removed entirely. In addition, portions of the icon can be manipulated using the tools from the dashboard. For example, colors of the character can be altered, the expressions on the faces may be changed and the character or item can be associated with preselected animations. Items from the dashboard may be associated with the character. For example, the character may be provided with a weapon, a wand, money, rope, tools, a map, matches, etc. These items can be displayed and then associated with the character, dragging the time to the designated character or by using other known navigational techniques, mouse pointer, etc.

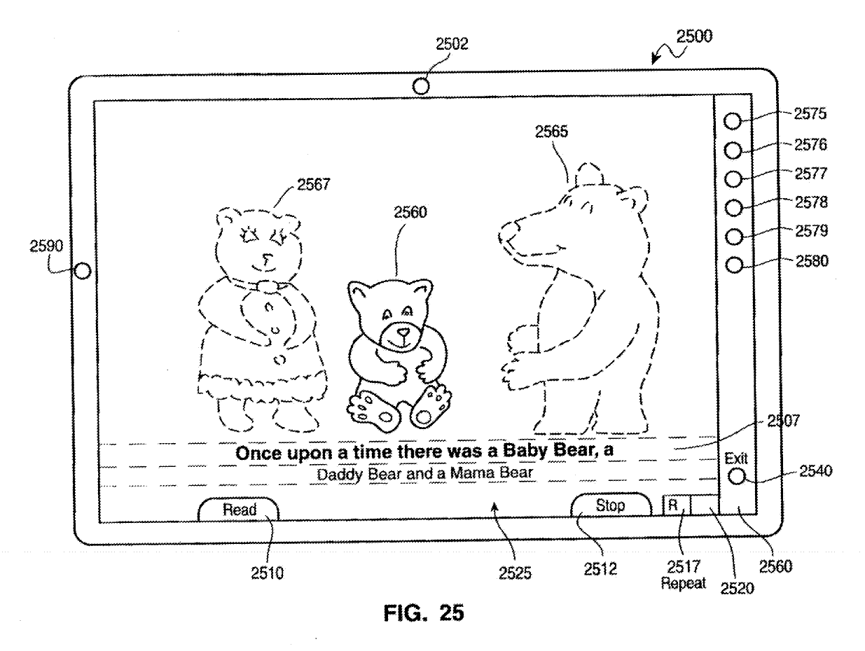

Thus, referring to FIG. 25, an embodiment of the invention, the system includes a tablet computer 2500 and camera 2502 that can be activated to take a picture. In response to a command from the user, an image captured from the camera, such a character or object, can then be described and incorporated into the story. In an embodiment, the image is captured by the device and then the user may further provided identification indicia such as words or tags and that can be associated with the image and incorporated into the image database.

In an alternative embodiment, after the image is captured, the system can then compare the image with existing images in the image database and then integrate related images into the story creation system.

Now turning to FIG. 6 this system is described by the following steps. The application is activated at step 601, and next at step 602, the camera input is activated. Next, at step 603, an image is captured wherein the user can control the activation of the camera and then save the image at step 604. At step 605 a processor is then instructed to compare the image captured to images in the database and, if a match is located to propose a match and theme at step 606.

The user can acknowledges or accepts the image match at step 607 or rejects the proposed match at step 608. If the user accepts the proposed match, the system proceeds to step 609 where the image is then correlated with associated images in the theme. If the user rejects the proposed match the system returns to step 606 where additional proposed matches may be proposed until or user provides an exit command, or the system indicates there are no other associated matches. If a match is successfully accepted, the user initiates dictation of a story using the matched image in the dictated story at step 610.

In an example of this feature of the invention, the software application is provided with a stuffed bear. Upon activated the user takes a picture of the stuffed bear and the software system will recognize the bear as corresponding with a collection of themes and line drawings of the bear. These themes can then be selected by the user. The user then can dictate a story about the bear, and the system will use the database images that correspond to the associated image.

In an alternative example, the camera may take a picture of a doll, or action figure that is provide with the device. In contemplated examples, dolls may include Barbie or Bratz dolls and action figures may include Superman, Spiderman, IronMan, Power Rangers, etc. Upon the recognition of the image by the camera, the system can then associate numerous related images to the matched images. These images can then be easily accessed by the database during the dictation step. Other related images can be displayed as icon in the dashboard section of the display to provide a suggestion to the user to integrate the image into the storyline. The related images are associated in the search engine algorithm that is used to associate images with the storyline. Since the icons are displayed, they may be accessed by the touch screen input feature. For example, the user may drag the icon of a related image into the display area to enhance the illustration of the dictated story. Thus, the user may select from a wide variety of icons to add illustration to the story as well as providing an impetus for creative storytelling. For example, the menu icons may include a random object such as key, rope, fishing rod, scuba tank. The user may select the key and then create a story about the found key and what the key may unlock. Icons relating to the locks may also include doorways, treasure chests, automobiles, aircraft etc. The user than can use his or her imagination, along with prompts from the dashboard in the form of icons, to allows the user to create different directions and story lines.

In addition, as the story is dictated, new images that related to the story may be displayed in the scenes or the environment that has been selected. These items can provide a prompt to the user to incorporate the image into the story. For example. The character may come across a key in the environment, and, the user may dictate that the character picks up the key. Later, the key can be accessed by the character to access other item in the story such as a castle door or treasure chest. If the key is not picked up, it will remain at the location in the environment. As such the character may be able to return to the location, if later it is desired to use the key. In another example, a tool is located in the environment that the character can use to perform a task. In this example, the may include an ax and the bear may chop wood using the ax. As the action is dictated by the user, images of the bear cutting wood can be displayed.

Changes in scenes may be directed by certain recognized phrases. For example, the phrase character X went ‘into the houses,” “into the castle,” “into the barn”, “into the building,” “into the cave,” “into the store,” etc., the next scene depicts Character X in the predetermined scene of a house, castle, barn, building, cave, castle, barn, building cave etc. In another example, the user dictate, that character x,—climbed a hill; climbed a tree, climbed a wall, climbed into bed. An image of the character in the act of “climbing” can then be displayed. Alternatively, the in the next image displayed, character may be displayed in the designated location (i.e. hill, tree, wall, bed). Alternatively, two images can be depicted in adjacent frames on the same display, one with the character in the act of climbing and a second image in the location. In yet further alternatives, a “climbing” animation sequence may be applied to the character.

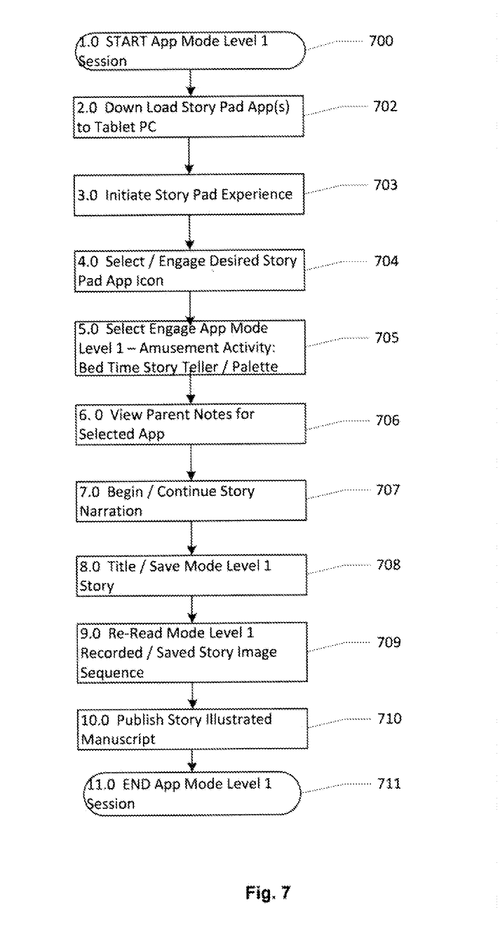

Now referring to FIG. 7, an alternative embodiment of a method of the invention begins at block 700 for Mode level 1 as described in Appendix A. First, (as designated “1.0 Start”) the application is downloaded onto a tablet PC at step 702. Next the system displayed an opening credit and start menu, such as that illustrated in FIG. 1 and the application is initiated at step 703. At step 704 the selected mode is selected, and in the example, the story teller mode is illustrated. At step 705 the mode is selected which may include any of the modes that are described in Appendix A. The selected mode depicted in fig. is for the bed time story mode and, in this embodiment, next parent notes and instructions are displayed at step 706. The user then is signaled to initiate the story narration at step 707. The story then progresses and includes step 708 to save the story as it progresses along with associated images and provide a title or file name to the record. Upon completion of the story, the user can access the stored data, including the audio file and image files that include the displayed text, at step 709. In subsequent step 710 the record may be printed or published in a machine readable multimedia media that can be accessed and played back to the user or others. The story and illustrations may also be printed out at step 710 where a manuscript of the story is provided to the user.

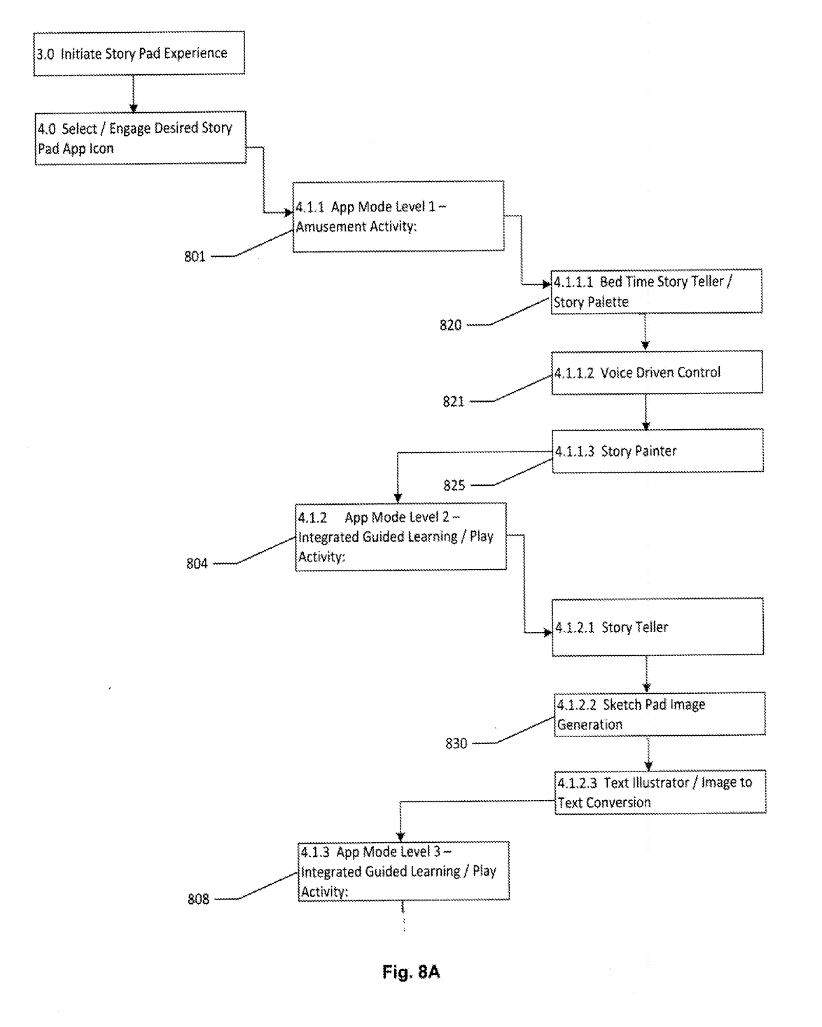

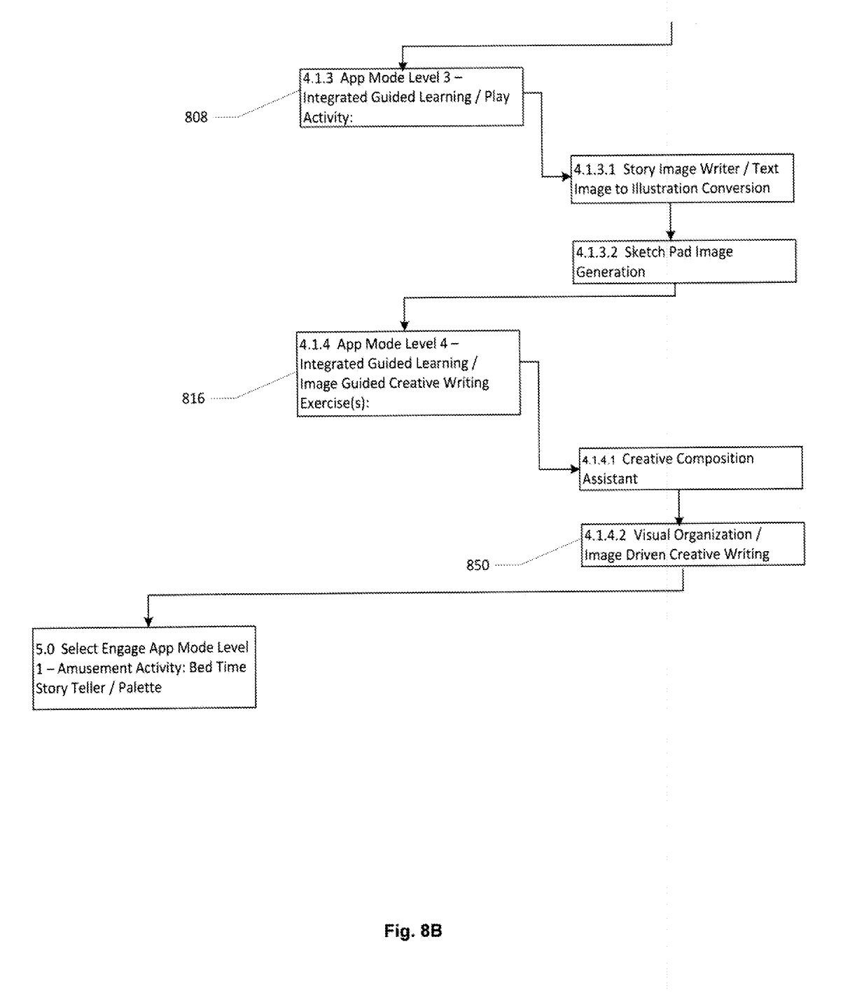

Now referring to FIGS. 8A and 8B and as further referred to in the Appendix, process steps for an amusement activity 810, Integrated Guided Learning 804 and 808, and Creative writing 816, are depicted. These sub steps can be activated at Step 4 as described above in the Story pad experience according to the invention.

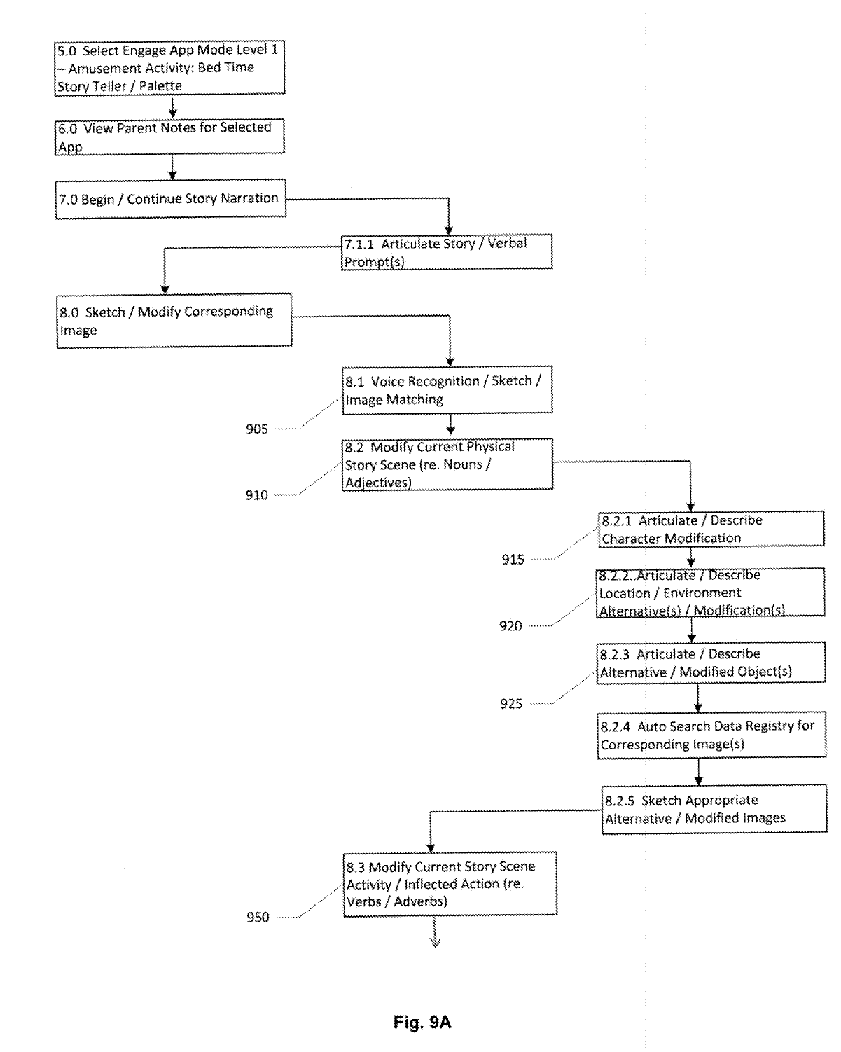

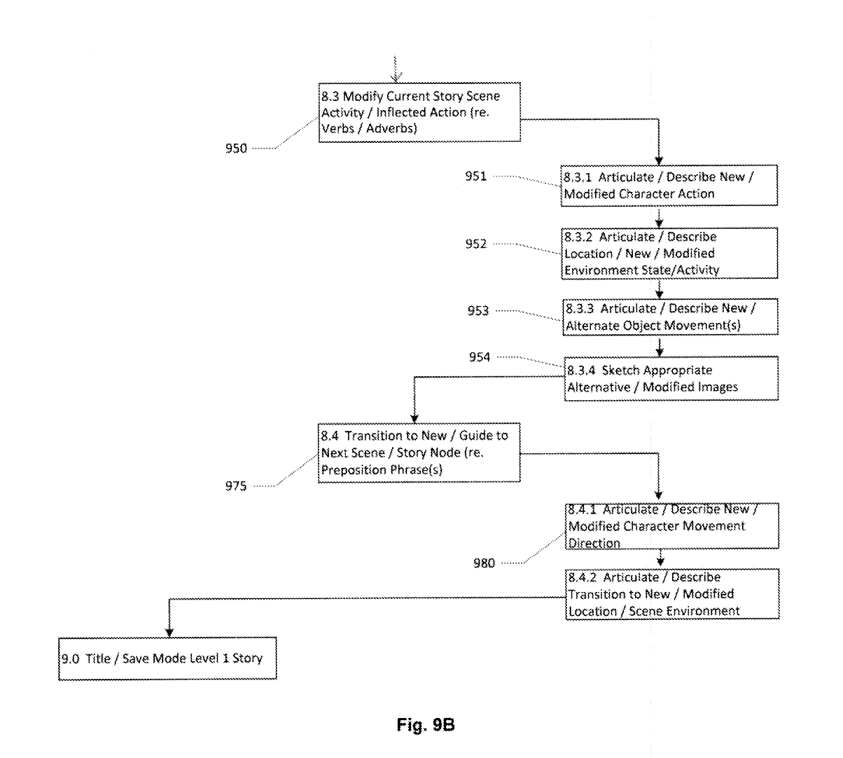

Now referring to FIGS. 9A and 9B, steps relating to the creation and display of images are depicted. There the voice recognition step 905 is includes the ability to modify the scene at step 910. For example, the user may describe or modify the character at step 915, including the location in the environment at step 920 (near a displayed object such as a rock, a tree; on a bridge, on a path, on grass, in pond, in creek, etc.). In addition, objects or items in the display may also be modified at step 925. For example, a bear character can locate and find a key, and then hold the key. If an image of the key is not in the image database, the user can sketch his own key or alternatively be directed to a browser to find an image of the key which can be further manipulated by the user. The user can then index the item and the processor would then have this image available in the database for user or future use in the story program.

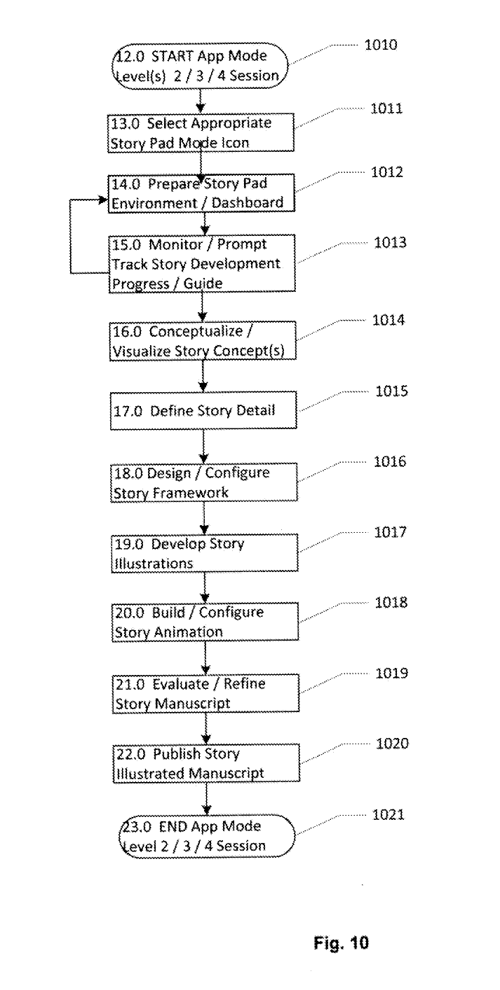

Now referring to FIG. 10, a high level flow chart for telling illustration and animating a story is depicted. In this embodiment the steps include starting the device at step 1010, selecting the story mode icon at step 1011, preparing the story pad environment dashboard at step 1012. This includes a step that includes a step 1013 to prompt the user to refer to a story development progress guide. Next the user conceptualized story concepts at step 1014. At step 1015 the story is detailed by the user, which leads to story framework steps 1016, and illustrations 1017. The process also includes an animation build strep 1018 and such animation can be applied to characters or objects. The story can then be refined at step 1019. The story can then be published by written or multimedia means. The multimedia can include an audio file, animation, test and other illustrations.

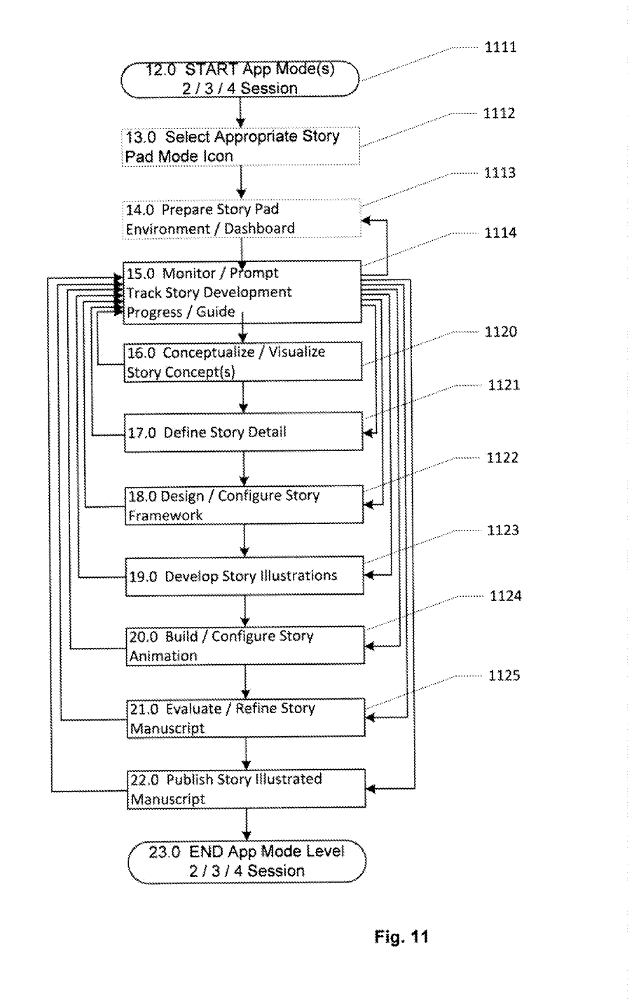

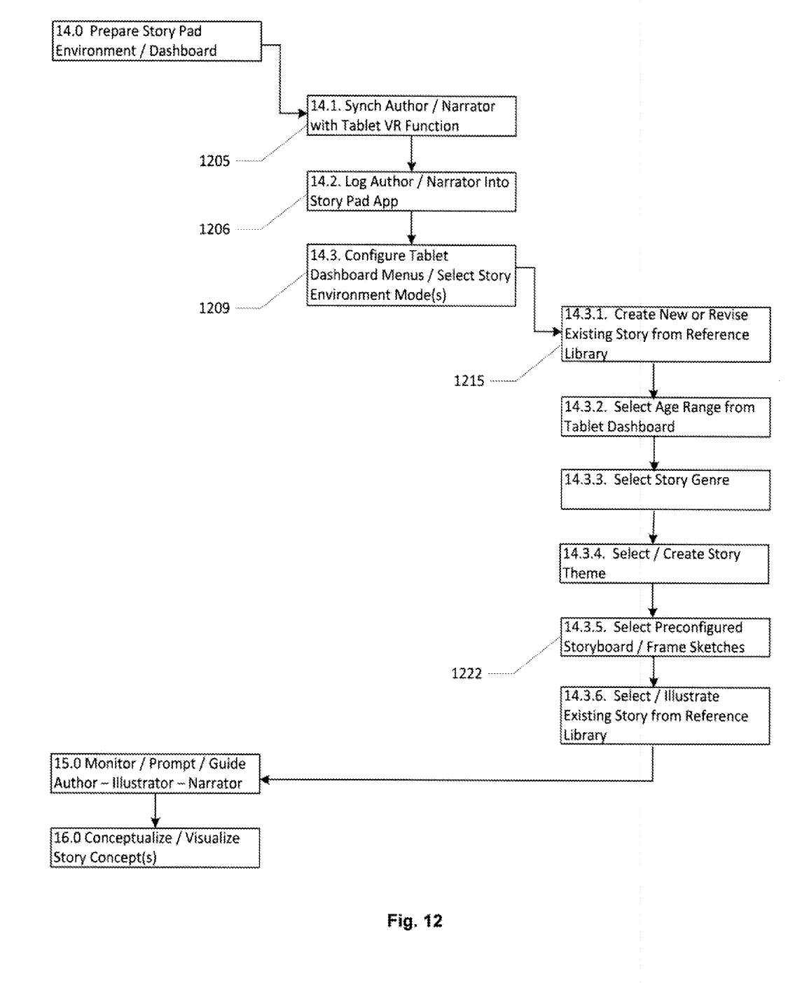

At FIG. 11, a solution step is illustrated as further described in Appendix A. In FIG. 12, feedback loops are illustrated that allow the user to return to the step 114 to track the progress of the story based upon a story development track or guide.

Now referring to FIG. 12, the steps relating to preparing the story pad environment dashboard are illustrated. These steps 1205 and 1206 include, voice recognition technology that recognize or synchronize the narrator of the story with the voice recognition function. In this regard, the voice recognition function can be trained with respect to particular sound of users of the device and, before the dictation begins the system can first match the user with the users profile to better recognize the audio signal. Next the story environment mode is selected at step 1209. The user then may begin to create a new story file by dictation, or may call up an existing story file and continue the narrative at step 1215. In this sequence the may also preselect characters, environments, objects and themes.

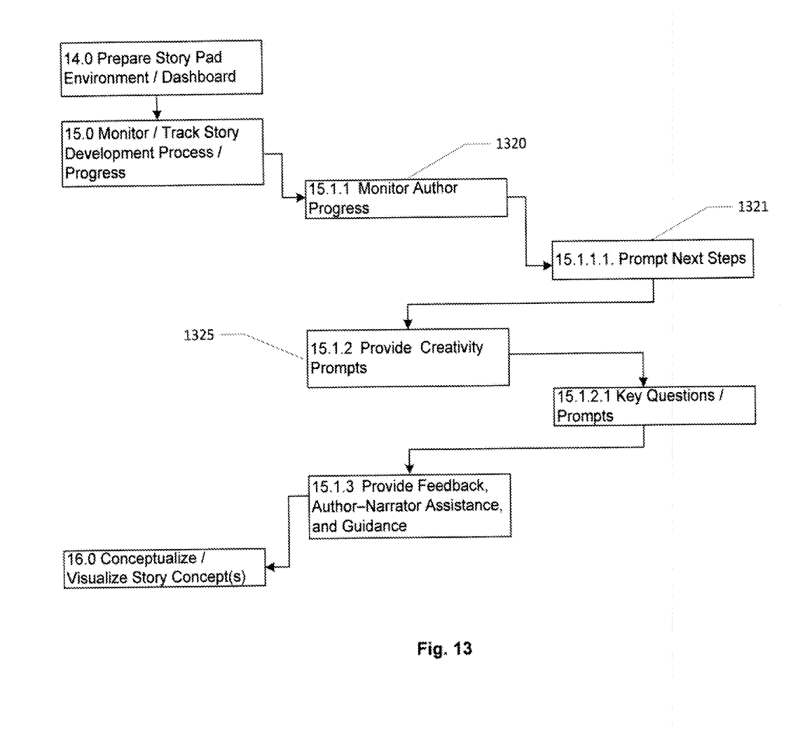

Another aspect of the present system is a prompt system that can monitor the progress of an author with respect to the creation of the story. As illustrated in FIG. 13, this feature which may be triggered by the detection of certain events (or lack thereof) in connection with a particular story theme, allows the system to prompt the user to consider additional actions. Thus at Step 1520, the system monitors the progress of the user at step 1320 and, may provide a prompt at step 1321. The prompt 1325 my take the form of a highlighted item or object in the dashboard, the introduction of an item or object in the next frame, or the highlighting of certain actions or animations in the dashboard. In alternative embodiments, the prompt may include a question posed to the user displayed in a portion of the display panel. For example, in an example, the system under a Goldilocks and the Three Bears theme prompts a bears character to climb the stairs to look in the bedroom upstairs. This prompt may be in the form of a question “did you want to look upstairs?” or the stairs in the displayed figure may be delimited by a halo or other indicator.

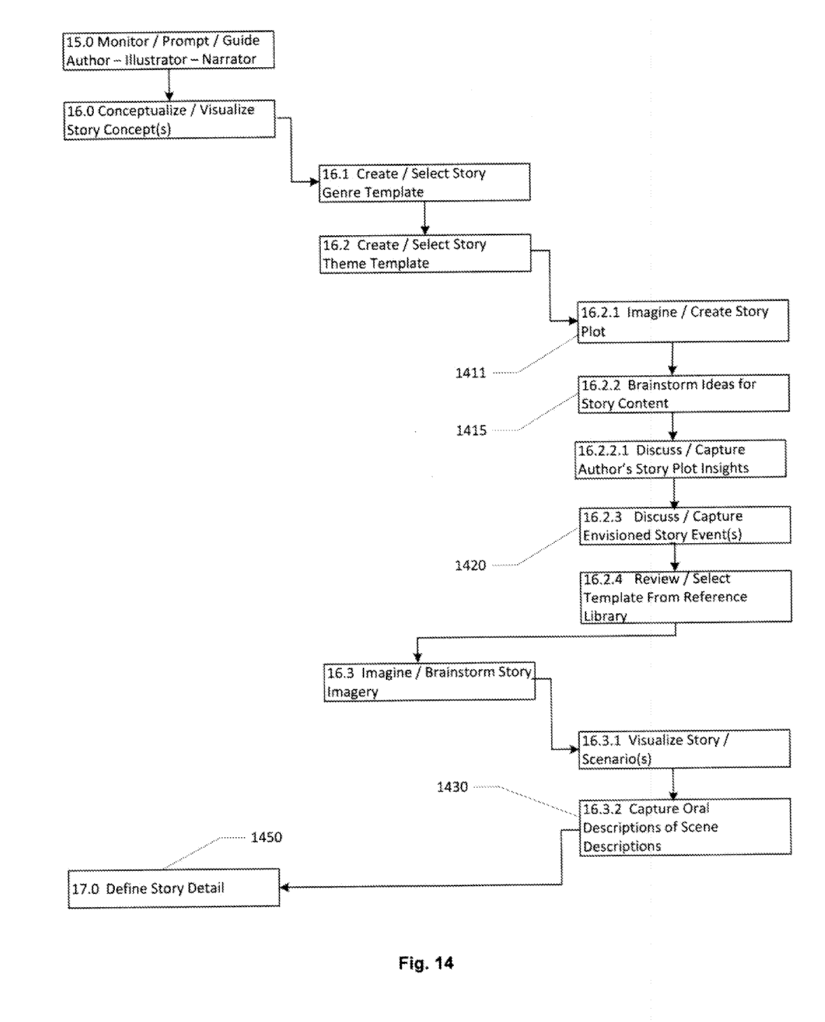

Now referring to FIG. 14, the system of the invention also provides for the planning of the story before it is dictated by providing the user with a series of instructional prompts. Thus, before initiation of the dictation step, the user is provided instruction on how to create a story, and such instruction is displayed on the tablet computer. Here, the steps include step 1411 create a story plot relative to the theme, step 1415 brainstorm with a partner or child, step 1420, discuss and create story events at step 20, and review of story templates from a reference library 1421 that includes possible plot lines and events. Next after, an outline is formulated, the story is dictated and captured by the device including scenes 1430, main characters 1430 and then the story detail at step 1450.

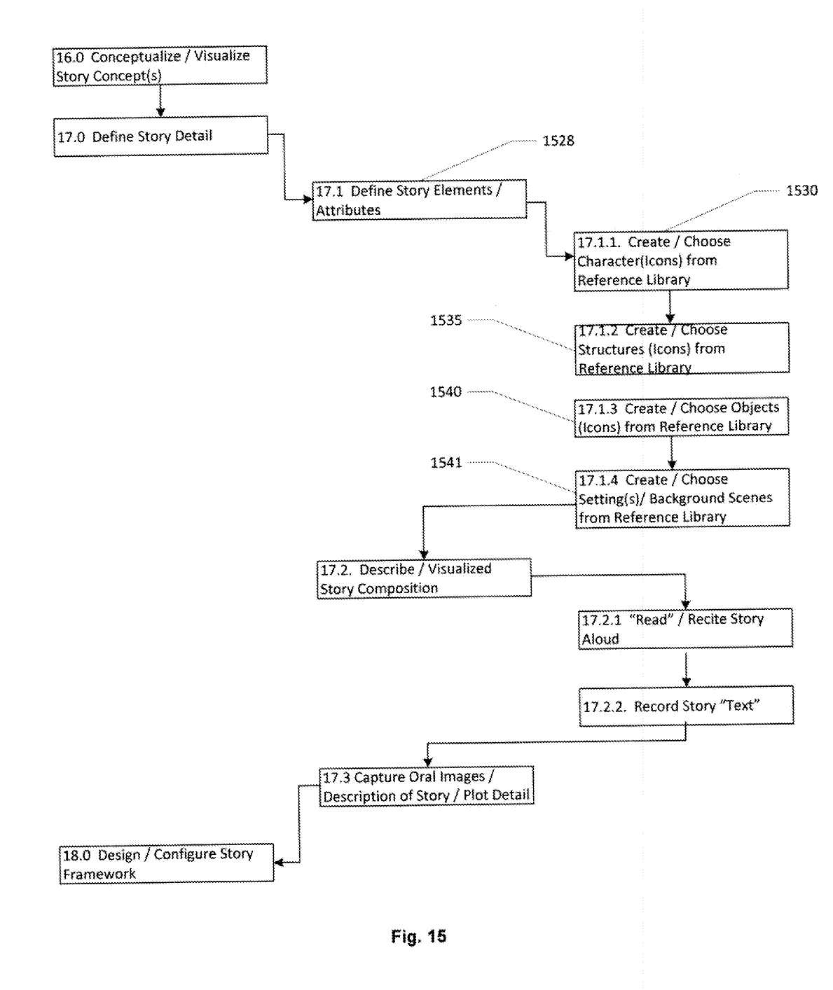

FIG. 15 illustrates further steps involved in defining the story detail including defining story elements 1528, the creating or selecting characters 1530 from a reference library or dashboard, refining characters and providing characters with unique character traits, clothing, style, behaviors, etc. (not shown). In addition, structures 1535, objects 1540 and settings 1541 may be selected from the library. Examples of structures include building such as houses, barns silos, malls, stores, fences, roads, paths, train tracks, stadiums, churches; Examples of objects may include money, weapons, tools, food, candles, sporting equipment; Examples of setting include country mountain, urban, riverside, Oceanside, etc.

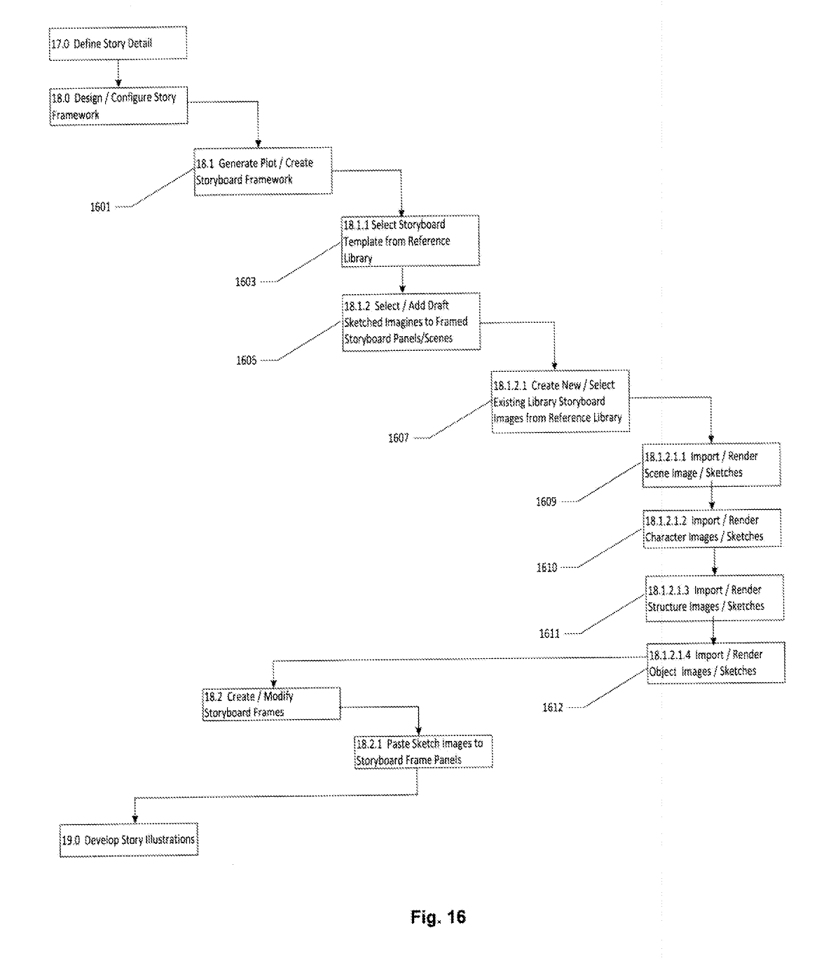

FIG. 16 provides yet additional process flows for the creation of a story wherein the user also creates the illustrations in the story including character sketches, environment sketches and object sketches that can be incorporated into a story or narrative.

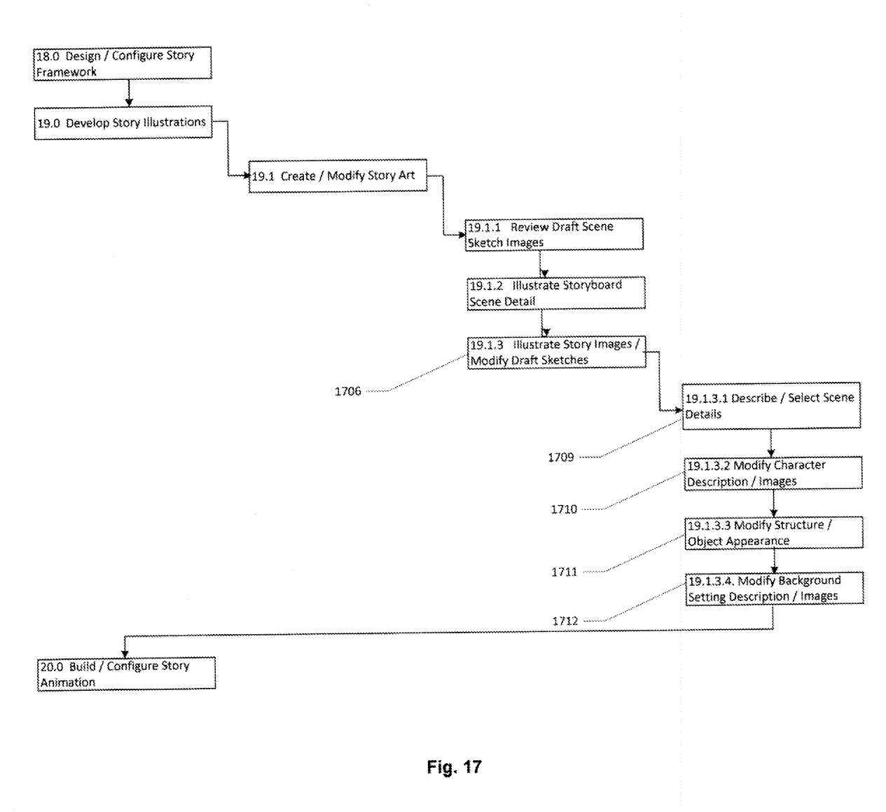

FIG. 17 is further illustration of process steps where, among others, illustrations are created or existing character or scenes and objects may be modified. For example at step 1706

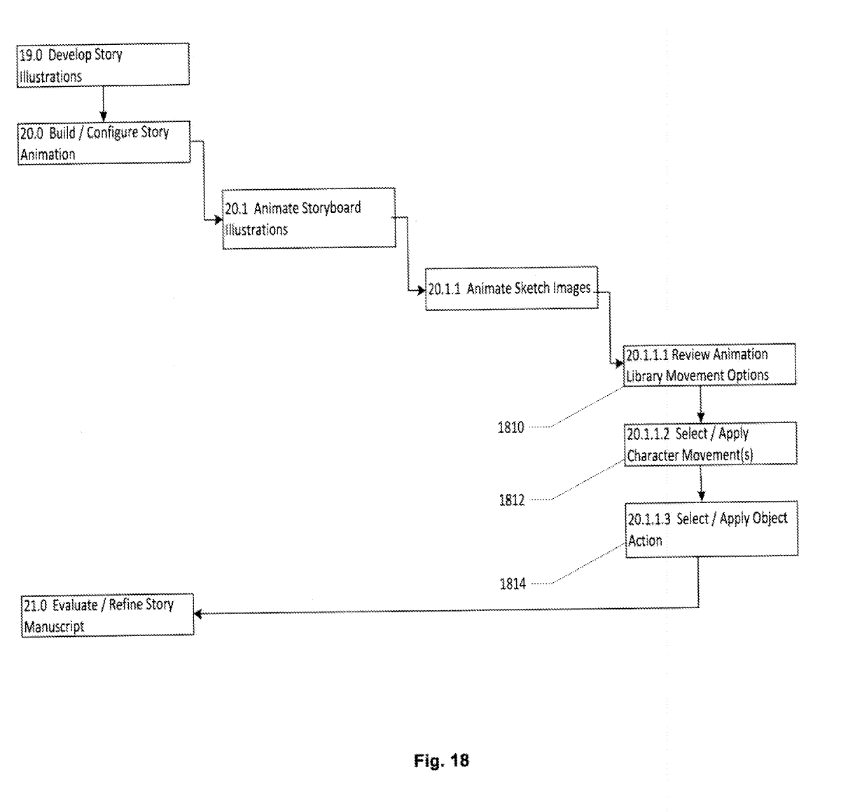

FIG. 18 depicts process flow relating to the animation step in embodiments of the invention including step 1010, the review of animation library movement options, step 1812, the selection and application of the movements to a character and step 1814. Accordingly, in embodiment of the invention libraries of images, including settings, environments, structures, characters and objects as well as animations are created and stored in an image database. In addition each of these items is indexed so that a search engine can locate the image and correlate the image with dictated text. Alternatively, the images may be manually selected by the user by reviewing the index or dashboard. Moreover, the images can be altered or modified by the user such as the image alternation interface depicted in FIG. 3.

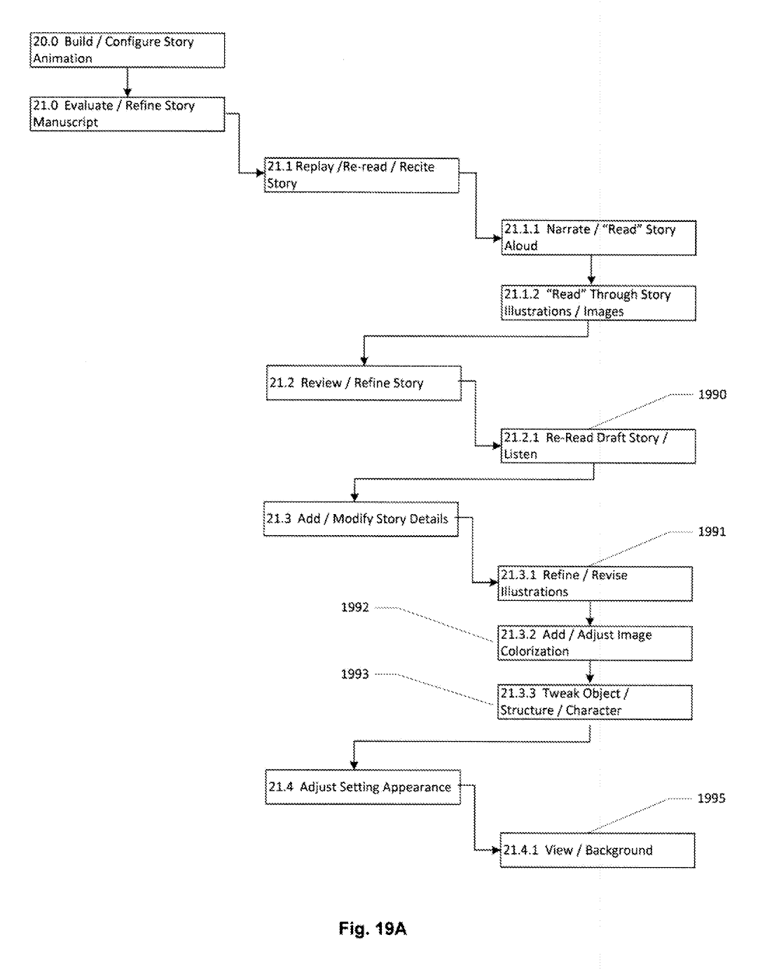

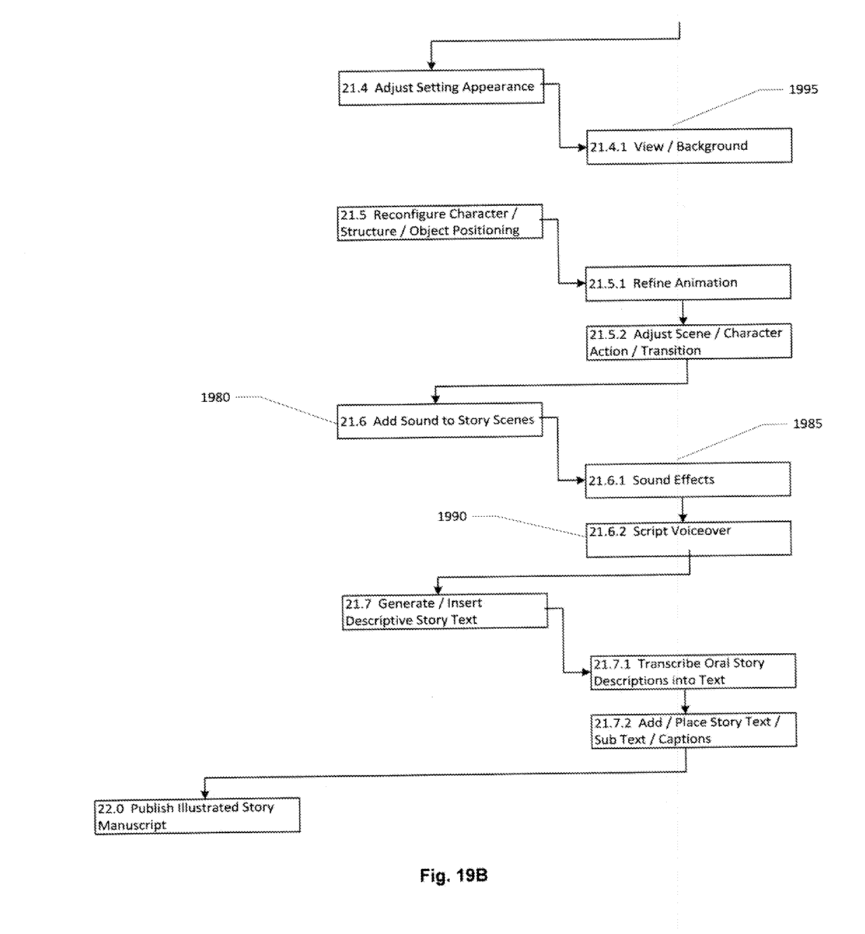

FIGS. 19A and B depicts process flows that can be followed to edit and modify stories that are created, including adding sound effects and voice overs.

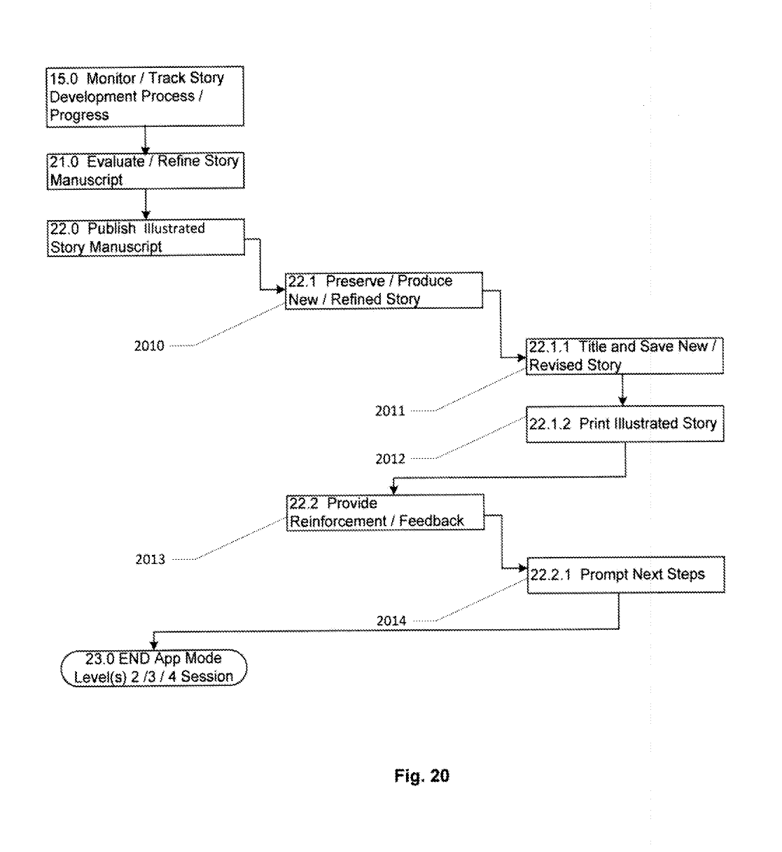

FIG. 20 is directed to publication steps of the illustrated story.

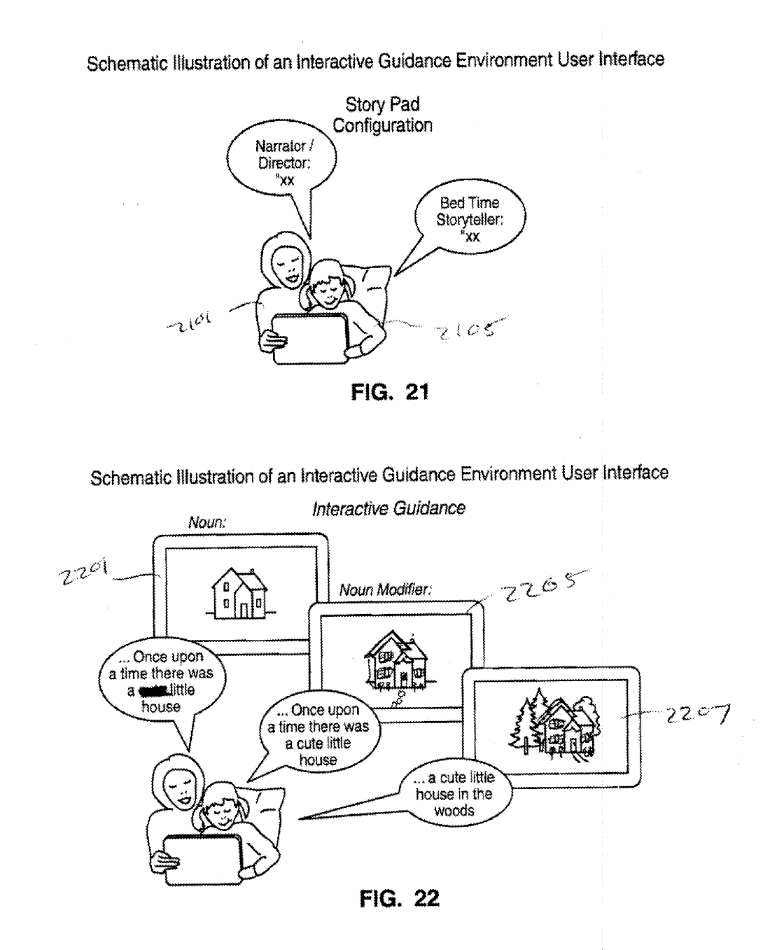

FIG. 21 is a schematic illustration of the device that includes two narrators.

FIG. 22 is a schematic illustration of the device, which depicts alteration of the image presented depending on the dictated and interpreted text.

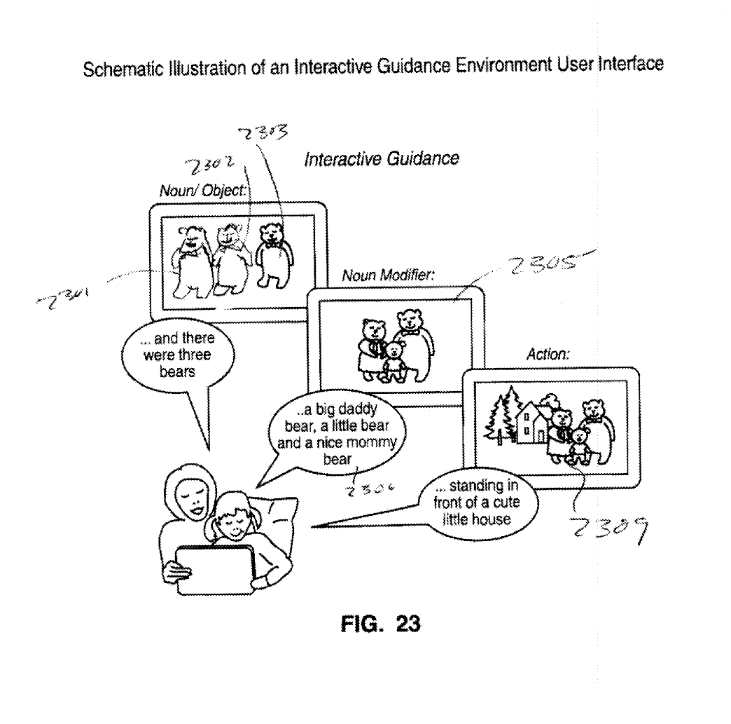

FIG. 23 is a schematic illustration of the device where different images are displayed depending on the dictated text.

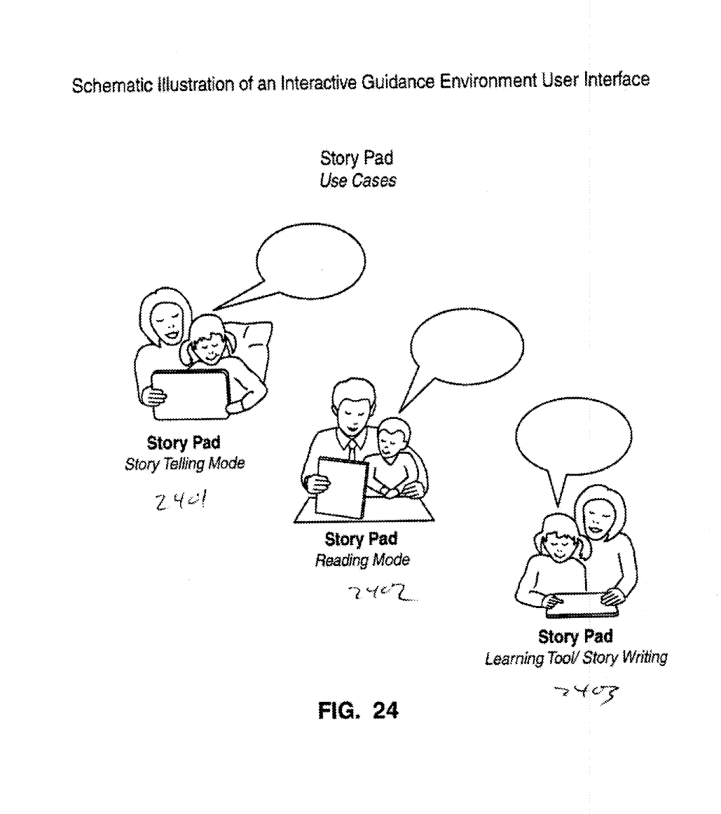

FIG. 24 is a schematic illustration of the different modes including storytelling, reading and a learning tool.

FIG. 25 depicts a tablet 2500 including camera 2502, and display 2525. The display include dashboard section 2560 and control read start control 2510 and read stop control 2510. The figure illustrates the device after a theme and back ground and other story elements have been selected. Repeat control 2517 is provided to allow user to repeat the dictated phrase before processing and control 2520 is provide to save the phrase. The dictated phrase is displayed in display region 2507. Exit control 2540 changes the display to other utilities that allow for the saving of the story, to select portions of the story, thumbnails of the story, and publication options. The dashboard 2560 also includes a plurality of additional options that can be selected by the user. For example, control 2575 opens a menu of characters that can be selected and modified, control 2576 includes structures that can selected and modified, control 2577 is a menu for a plurality of objects that can be selected and modified, control 2578 opens a menu for different animations that can be applied to objects and characters, control 2979 is a further control that permits the selection of scenes and control 2580 is a control that allows for the selection of weather conditions. The user can exit the application by the control of switch 2590. As illustrated in FIG. 25, a single baby bear 2565 has been illustrated. As the illustration continues, in this display, the processor will draw the bear depicted in the dotted lines as 2565, a daddy bear, and then a mama bear 2567 depicted in broken lines. The broken lines are not displayed but reflect the location of a future illustration. If the scene had been selected, the bears would be depicted in a selected environment. For example, in FIG. 26, the display depicts the bears in an environment that includes a woods area 2610 and a structure 2615. Each of the images 2602, 2650 2615, 2610 and 2655 depicted can be selected for using the touchscreen for further modification. For example, if image 2602 is touched, a halo is provided around the image and it can be edited, removed, an animation can be applied to the image.

In an example of the use of the device, if the system is in ready mode and the user can then dictate a further sentence, for example, the bears walked to the house. The next image would depict the bears walking toward another view or image of the house structure 2615 that was depicted in FIG. 26 and the text would be displayed text field 2507. If the user dictated that the “the bears looked at the door”, an image of a door of the house would be depicted. If the user then dictates that the “bears opened the door and went inside”, the processor could show a door opening image and, in the next scene show the bears inside the house. Not all possible images that are associated would necessarily be presented to the user. For example, the logic may disregard the phrase “open the door” and move directly into the house.

In general, the embodiments of the invention include a speech recognition system embedded in a tablet computer that includes a microphone. The device receives an initiation signal from the user, which may encompass the activation of a switch, or other input device to reflect that a microphone is active, as well as the speech recognition system. In embodiments the speech recognition system acknowledges that it is ready to receive speech input (“ready response”). This may be done by providing an audio recording of a prompt term, or turning on a light indicator, or another audible feedback, including a beep. In embodiments, the signal to begin speech is a green light. In embodiments a first prompt term may be the phrase “Once upon a time.” And, as the story progresses, other terms may be used such as “Meanwhile,” “Next” or other prompts that are story subject specific such as “back at the headquarters.”

After a predetermined time period that follows the “ready response” the automatic speech recognition system (“ASR”) system listens for user speech input. In an embodiment, if the user begins speaking before the ready response, the ASR will determine that the user has talked prematurely. This occurs if the user speaks before the first time delay after the “ready” playback has expired, or if the user speaks before the playback of “ready” is finished. The ASR system then outputs an error associated with a premature signal and advises the user with a visual and or audio output and prompts the user to begin the process again. In embodiments, this is done by flashing a yellow light provided on the tablet or dashboard that provided on the display of the tablet. The ASR may also play a message to the user to please repeat the sentence or phase.

Upon reception of a full sentence or phrase, the system detects a pause which will cause the ASR system to generate a signal to deactivate the microphone is off. Each phrase of sentence is referred to as a speech segment. In alternative embodiments, the microphone is activated for a predetermined time during which it can receive the auditory signal to create a speech segment. The signal to the user that the microphone is off may be a red light, a beep or other an auditory signal, or a signal that is displayed on the tablet. In embodiments, after dictation, the recorded he speech segment is played back to the user for an approval input. If the user is satisfied with the speech segment, the method proceeds. If the user is not satisfied with the speech segment, the user may delete the previous speech segment (or other selected speech segments that can be navigated using the dashboard) and elect to record a new segment at the speech segment frame. Each speech segment frame is provided with a unique identification number or code. In alternative embodiments, the audio recording is repeated and played back only in responses to a user's command. The user playback command may be activated from a dashboard or using other input means.

Next, noise residue, which may be background sounds, are filtered from the signal. Filtering the noise residue may be accomplished in any one of a number of ways, as is well known in the art. The system of embodiment of the invention then processes the filtered voice command, and in embodiments, these processing steps may include a translation of the auditory to text, which is then displayed on the tablet screen. Se FIG. 25 field 2507. In addition, a further algorithm is applied to the text from the frame to select relevant graphics. Here the term graphics may include background images, images of objects and images with animation.

In the event that the speech segment or phrase does not have image that is associated, the system will provide a signal to the user. The user may elect to disregard the previous phrase, or merely proceed without a new image or altered image that directly corresponds with the speech segment or phrase. This step can be implemented by the activation of a switch or program command, or the system can signal that no image is available by an output and the system is then prepared for the next dictated segment.

The system then stops and waits for the next user command. In one embodiment, the system remains in the premature enunciator mode until the system is turned off. In another embodiment, the ASR system resets the premature enunciator mode to its normal mode of operation with the regular listening period interval of 50 ms as soon as the first command is processed. If the reset is user controlled, means for resetting the system are provided. The means for resetting the system may comprise a reset button, or other system known to those of skill in the art.

The above-described methods and implementation for intelligent speech detection and associated information are example methods and implementations.

In embodiments of the invention, after an image is selected for display, the processor creates the drawing by extending a lines or a plurality of lines from a starting point, thereby simulating the hand drawing of a line figure. In this regard, in preferred embodiments, the images are comprises of line drawings that can be easily manipulated by the processor into other shapes. For example, in a preferred embodiment line drawings are used to define characters. Using line drawing allows and known programs for automation for line drawings, allows for the easy integration of actions to characters as well as multiple poses. IN alternative embodiments the image may fade into the display, or be created on the display simulating the creating of a drawing on a line plotter or dot matrix printer.

In the event that no images are located in response to the system, a signal is generated and the user can proceed without an image of the preceding phrase. Alternatively, the user can actively seek for a relevant image to sentence phrase by accessing the image database, or selecting from an external locations, such as on the world wide web, or the user can create his or her own image by accessing a personal or private image database, that may include original photographs and original sketches created by the author.

As the story progresses effects can be associated with the images including animation. These effects can be associated using the voice recognition system or be s selected using other input systems, such as from the dashboard or from the touchscreen. For example, if the characters are moving from a first location to second location on the display screen, the can display animation showing the movement from a first location to a second location. Thus, if the user dictates that the bears went into the house, the bears could be depicted moving toward the house and then the next when the bears are shown within the house.

In another example, a bears may be described as walking through a forest. Once again the system would first display an image that was on the display screen, such as a field and the next image would show the bears walking in a forest as opposed to the country side. If the user describes that the bear sees an object, the object can appear on the screen. For example, if the bears see a stream, the stream can be illustrated. If the user dictates that the bear crosses the stream, the next image is a bear on a bridge over the same stream. Other items in the background would remain the same.

In embodiments, the system is further provided with a menu that may include story themes and a set of suggested nouns, verbs and adjectives relating to the preselected theme. In the embodiment discussed above, the user is first directed to display screen that includes a selection for predetermined themes, for example, the may relate to a medieval with castles, dragons, sword fighters and a prince and princess and royal family. The user may select a cast of preselected characters from the menu page that can be introduced into the story. The menu is displayed on a dashboard to suggest certain action or words and the interaction with certain characters.

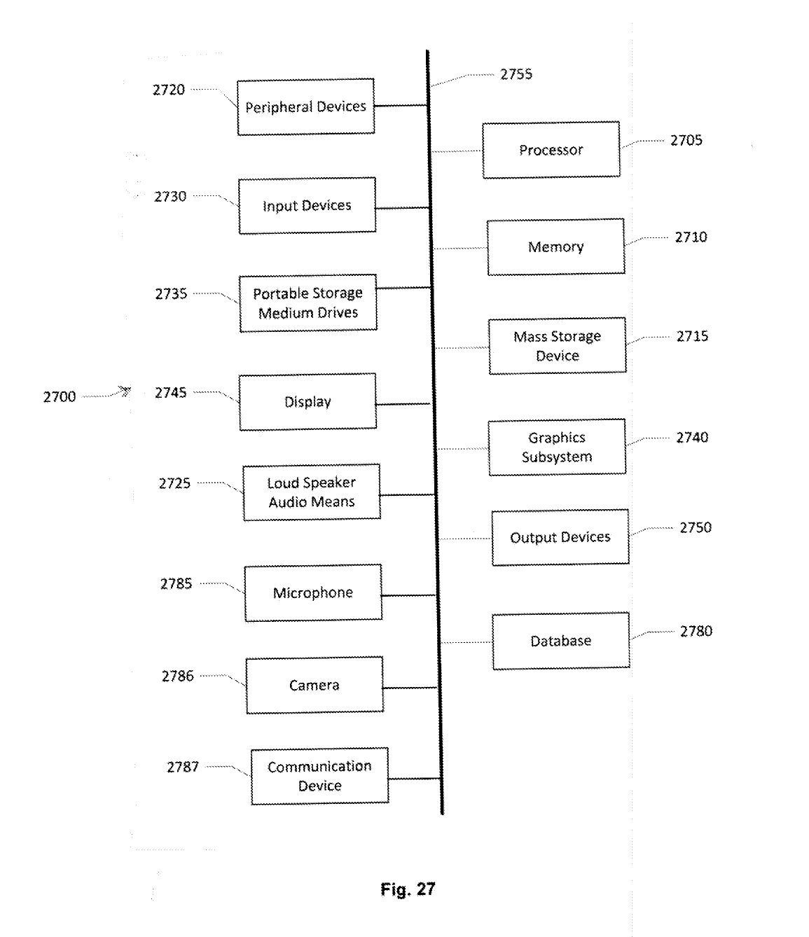

FIG. 27 is a block diagram of a data processing apparatus 2700 that can be incorporated as part of both the system and method of the invention. The data processing apparatus 2700 includes a processor [2705 for executing program instructions stored in a memory 2710. The memory 2710 stores instructions and data for execution by processor 2705, including instructions and data for performing the methods described above. The data includes the various reference standards. Depending upon the extent of software implementation in data processing apparatus 2700, the memory 2710 stores executable code when in operation. The memory 2710 includes, for example, banks of read-only memory (ROM), dynamic random access memory (DRAM), as well as high-speed cache memory.

Referring now to FIG. 27, within data processing apparatus 2700, an operating system comprises program instruction sequences that provide a platform for the methods described above. The operating system provides a software platform upon which application programs may execute, in a manner readily understood by those skilled in the art. The data processing apparatus further comprises one or more applications having program instruction sequences according to functional input for performing the methods described above.

The data processing apparatus 2700 incorporates any combination of additional devices. These include, but are not [limited] limited to, a mass storage device 2715, one or more peripheral devices 2720, a loudspeaker or audio means 2725, one or more input devices 2730 which may comprise a touchscreen, mouse or keyboard, one or more portable storage medium drives 2735, a graphics subsystem 2740, a display 2745, and one or more output devices 2750. The input devices in the present invention include a camera and microphone. The various components are connected via an appropriate bus 2755 as known by those skilled in the art. In alternative embodiments, the components are connected through other communications media known in the art. In one example, processor 2705 and memory 2710 are connected via a local microprocessor bus; while mass storage device 2715, peripheral devices 2720, portable storage medium drives 2735, and graphics subsystem 2740 are connected via one or more input/output buses.

In embodiments, computer instructions for performing methods in accordance with exemplary embodiments of the invention also are stored in processor [1705] 2705 or mass storage device 2715. The computer instructions are programmed in a suitable language such as C++.

In embodiments, the portable storage medium drive 2735 operates in conjunction with a portable non-volatile storage medium, such as a floppy disk, CD-ROM, or other computer readable medium, to input and output data and code to and from the data processing apparatus 2700. In some embodiments, methods performed in accordance with exemplary embodiments of the invention are implemented using computer instructions that are stored on such a portable medium or are downloaded to said processor from a wireless link

Peripheral devices 2720 include any type of computer support device, such as a network interface card for interfacing the data processing apparatus 2705 to a network or a modem.

Still referring to FIG. 27, the he graphics subsystem 2740 and the display 2745 provide output alternatives of the system. The graphics subsystem 2740 and display 2745 include conventional circuitry for operating upon and outputting data to be displayed, where such circuitry preferably includes a graphics processor, a frame buffer, and display driving circuitry. The display 2745 may include a cathode ray tube display, a liquid crystal display (LCD), a light emitting diode display (LED) or other suitable devices. The graphics subsystem 2740 receives textual and graphical information and processes the information for output to the display 2745.

Loudspeaker or audio means 2725 includes a sound card, on-board sound processing hardware, or a device with built-in processing devices that attach via Universal Serial Bus (USB) or IEEE 1394 (Firewire). The audio means may also include input mean such as a microphone for capturing and streaming audio signals. In embodiments, instructions for performing methods in accordance with exemplary embodiments of the invention are embodied as computer program products. These generally include a storage medium having instructions stored thereon used to program a computer to perform the methods disclosed above. Examples of suitable storage medium or media include any type of disk including floppy disks, optical disks, DVDs, CD ROMs, magnetic or optical cards, hard disk, smart card, and other media known in the art.

Stored on one or more of the computer readable media, the program includes software for controlling both the hardware of a general purpose or specialized computer or microprocessor. This software also enables the computer or microprocessor to interact with a human or other mechanism utilizing the results of exemplary embodiments of the invention. Such software includes, but is not limited to, device drivers, operating systems and user applications. Preferably, such computer readable media further include software for performing the methods described above.

In certain other embodiments, a program for performing an exemplary method of the invention or an aspect thereof is situated on a carrier wave such as an electronic signal transferred over a data network. Suitable networks include the Internet, a frame relay network, an ATM network, a wide area network (WAN), or a local area network (LAN). Those skilled in the art will recognize that merely transferring the program over the network, rather than executing the program on a computer system or other device, does not avoid the scope of the invention. For instance, the Database may not be in proximity to the processor and the processor may communicate remotely with the database. In other contemplated embodiments, images may be located, downloaded and displayed and from the internet.

Image Comparison Software

There exist a number of commercially available algorithms for the selection of pre-tagged or indexed images from a search engine query or natural language query that can be adapted for use in the present invention. As discussed above, after the audio signal has been converted to text, images and, in some embodiment's actions, are associated with the converted text. Image and action application association algorithms can be achieved using a variety of conventional keyword and database search technologies, using the sentences or phrases of the converted text in a search engine query that is applied to the selected database. The term “Action Applications” as used herein are programs that are associated with specific characters or items to provide specific actions in the form of animated images. Such Action Applications may comprise JAVA based applications, applets or GIFs.

In embodiments, the search engine algorithm first seeks related images based upon the predetermined data tags that have been previously associated with the images and which correspond to the selected theme. In an alternative embodiment, the system uses natural language and artificial intelligence techniques to directly convert the dictated text with a related image or action and thereby omits the step that involves the translation of the audio transmission to text.

One type or natural language processing algorithm that has been developed is based on machine learning. In this type of algorithm, rather than coding of large sets of rules and heuristics, a machine-learning system employs general learning algorithms that may also use statistical inference to automatically learn language rules by analysis of large set of examples. In practice, a large set of text is first hand-annotated with the correct values to be learned. Many take as input a large set of “data features” that are generated from the input data. Some algorithms, such as decision trees types, consist of systems that use if-then rules to reach an output. Alternatively, algorithms may use statistical models to make probabilistic decisions based on attaching valued weights to the input feature.

Automatic learning procedures applied to algorithms that employ statistical inferences can produce models that are robust to unfamiliar input (e.g. containing words or structures that have not been seen before) and to erroneous input (e.g. with misspelled words or words accidentally omitted). Systems based on automatically learning the rules can be made more accurate simply by supplying more input data. However, systems based on hand-written rules can only be made more accurate by increasing the complexity of the rules, which is a difficult and time consuming process. While hand written rules may be effective when the image database is limited, as the size of the image database and the complexity of a particular story becomes complex, the use of hand-written rules becomes impractical. As such, it is generally easier to employ automated machine-learning systems as the complexity of the systems increase.

In general, natural language searches to use natural language processing to understand the nature of the question and then to search and return a subset of a database, or unstructured data such that available on the world wide web, that contains the “answer” or relevant responses to the question. Examples of current applications that use natural language recognition in commercial systems include Ubiquity, Wolfram, Alpha, Siri, Ubiquity is system that includes natural-language-derived commands that allow a user to get information and relate it to current and other webpages. Wolfram Alpha is an online service that responds to factual queries directly by computing a response or answer from structured data, rather than providing a list of documents or web pages that might contain the answer as a search engine. The Wolfram Alpha system was released in 2009. Siri is a natural language application for the iOS operating system. It uses natural language processing to provide responses to questions by listing a plurality of possible responses. Siri's application includes logic that also allows it to adapts to a user's individual's preferences over time and personalizes results based upon location. A further similar technology is offered by RightNow Technologies, referred to as Q-go, and provides an output response to a user's query on a subscriber's internal company's internet website or corporate intranet. The queries may be formulated using natural sentences or keyword input.

There are many commercially available search engines that can recognize natural language from a text input and provide a response. For example, Ask.com was traditional keyword searching with an ability to get answers to questions posed in everyday, natural language. The current Ask.com website still has this functionality. C-Phrase—is a web-based natural language front end to relational databases. C-Phrase runs under Linux, connects with PostgreSQL databases via ODBC and supports both select queries and updates. C-Phrase is hosted on Google Code site. Other search engines that use natural language proceeding include, Hakia, Duck Duck Go, Lexxe, Pikimal, Powerset (Microsoft), Start (Massachusetts Institute of Technology—project), Swingly, Yebol, inbenta, and Mnemoo

As discussed above, the invention may access a finite-state databases that have collection of images marked, tagged, characterized, or indexed with relevant data that may be recognized by the search engine as intelligible or natural language data. Such marked data may subsequently be further processed using natural language applications, such as categorization, language identification, and search.

Once a record image is processed relevant data may be indexed for the purpose of querying information in the record. An index is generally a data structure that may be used to optimize the querying of information, by for example, indexing the subject matter including elements and sub elements in the image. In an example, the image database may include multiple images of bears, and multiple images of item that the bear can interact with. The item images include but are not limited to picnic baskets, food items, a flashlight, lanterns, cameras, musical instruments, phones, sports equipment and balls, pens, pencils, paper, utensils and dishes, money, tools and weapons.

Palo Alto Research Center (PARC) has developed and commercialized natural language technology that has been used in various natural language applications, as described in “PARC Natural Language Processing”, Media Backgrounder, March 2007. PARC finite-state natural language technology includes authoring and compiler tools for creating finite-state networks, such as automata and transducers, as well as, runtime tools for applying such networks to textual data. Finite-state networks may be compiled from different sources, including publically available image databases. In addition, the may include expressions, a formal language for representing sets and relations. A relation is a set of ordered string pairs, where a string is a concatenation of zero or more symbols. Further, calculus operations may be performed on networks, including concatenation, union, intersection, and composition operations, and the resulting networks may be determined, minimized, and optimized.

In a further contemplated example, just like the theme may be from a well know children's story, other stories can be sued advantageously with the invention. For example, the Theme selected may be superhero such as Spiderman and the image library may contained multiple related images such as Uncle and Aunt, girlfriend, school rival, school friend, and a series of his enemies. As one skilled in the art can appreciate, a wide variety of stock images can be that relate to particular character sets. Character sets as well as related items, and scenes can be provided to the user in expandable database modules. As such, for example, if the user selects a Spiderman theme, the scenes provide may include urban city scene, a school, his home, a laboratory, etc. The items provide my include a guns, police cars, taxicabs, webs, cameras, photos, etc.; as well as other graphic images that depict the respective powers. Because these scenes that are selected by the search engine are all from a predetermined image library associated with Spiderman, the display of the story will have a consistent look and feel.

When the user dictates the story, the search algorithm find associated images and displays them with the dictated text. For example, Character X went to school; Character X sees his friend Character Y; Character X gets into a fight with Character Z and loses; Character X obtains superpower A, Character fights character Z and wins.

In embodiments, when the algorithm identifies that a character is thinking about an item or character, the system will depict an image of the object in a “thought bubble.” If a character sees something or something, the system will provide an image of the item or character. The system will generally present a new image, or amend an existing image after the completion of each phrase. If no image is identified, the algorithm will move to the next phrase. Thus, the algorithm will search the database and find a corresponding image that will be used in connection with the execution of the system of the invention.

In yet a further alternative embodiment, the generating an interactive story is provided on a global computer network such as the Internet. A user may access a web site upon which the system is provided, and thereafter create a story using the active and descriptive words and the commonly-used parts of speech and phrases. The benefit of having such a system available online is that it allows multiple users to access the system and generate stories with using different pictures, images, line drawing or photographs selected from the world wide web using a search engine technology.

Various other improvements and modifications to this invention may occur to those skilled in the art, and those improvements and modifications will fall within the scope of this invention as set forth below

We claim:

1. A system for the creation of an illustrated essay, short story, or instructions comprising an input devices, a processor, a display, machine executable instructions responsive to input and a database and wherein in response to said input said processor locates a corresponding image elements and then provides output comprising a display of said image elements that relates to said input.

2. The system recited in claim 1 wherein said input devices comprises a microphone for capturing audible input and said system further comprises voice recognition technology logic wherein a signal from said voice recognition technology is processed by said machine executable instructions and provides as output a corresponding image element that is displayed on said display and said image correlates with said signal.

3. The system recited in claim 2 further comprising voice recognition technology logic for processing of said audible input that provides a display of text that correlates with said audible input.

4. The system recited in claim 2 wherein said input to said machine executable instructions further includes data that reflects the present state of said visual display and said machine executable instructions alter the existing display.

5. The system recited in claim 2 wherein said machine executable instructions provides animation effects to discrete elements reflected in said display.

6. The system recited in claim 1 wherein said database comprises a plurality of images and each said images are correlated to a predefined theme.

7. The system of claim 6 further comprising input means to select said theme.

8. The system recited in claim 1 wherein said input devices further comprise a keyboard.

9. The system recited in claim 1 wherein said user input further comprises a camera.

10. The system recited in claim 1 wherein said processor and display further comprises a tablet computer.

11. The system recited in claim 1 further comprising a prompt display and input device to save a displayed image and any associated files in a memory.

12. The system recited in claim 9 wherein said camera captures images from the environment and said images are processed and made available in said database.

13. The system recited in claim 9 for comprising image processing logic for processing said captured images and said logic comprises input fields for correlating said captured images with relevant and searchable information relating to said images in a database.

14. The system recited in claim 9 wherein said image logic processing logic further comprising segmenting said captured images into discrete image elements.

15. The system recited in claim 2 wherein said voice recognition technology logic provides a signal and said signal is further processed to identify predefined parts of speech including nouns, articles, verbs, adjectives, prepositions, and conjunctions.

16. The system recited in claim 1 wherein said display images further comprises settings and said settings may be altered by the user according to predefined commands.

17. The system recited in claim 16 wherein said predefined commands further comprise audio inputs.

18. The system recited in claim 16 wherein said predefined commands comprise manual inputs.

19. The system recited in claim 17 wherein said manual inputs comprise a touch screen.

20. The system recited in claim 1 wherein said output further comprises a speaker to broadcast sound effects and said sound effects may be selected from a database and can be correlated to corresponding with the display of an image.

21. The system recited in claim 1 wherein said output further comprises a speaker and said sound effects that are predefined in audio files accessible in a database

22. The system recited in claim 1 further comprising a speaker and a microphone, a memory and signal processing logic, said microphone for capturing user created sound effects and said memory for saving said sound effects in an audio file and an input device for providing input data correlating to said audio file to allow for access to said file during use in response to predefined commands to associate said audio file with a particular display.

23. A method of creating and saving a narrative on a computer system, said computer system, said computer system comprising input devices, a processor, a display and a memory, said method comprising selecting a theme, selecting options relating to said theme, selecting characters relating said theme, dictating a narrative relating to said selected characters into a microphone, reviewing a display of an output responsive to said narrative.

24. The method recited in claim 23 further comprising selecting character options.

25. The method recited in claim 23 further comprising saving said display in a memory.
